(19) United States
(12) Patent Application Publication
(10) Pub. No.: US 2018/0034112 A1
(43) Pub. Date: Feb. 1, 2018

(54) NON-AQUEOUS ELECTROLYTE SECONDARY BATTERY

(71) Applicant: Sanyo Electric Co., Ltd., Daito-shi, Osaka (JP)

(72) Inventors: Natsumi Goto, Hyogo (JP); Katsunori Yanagida, Hyogo (JP); Masanori Sugimori, Hyogo (JP)

(73) Assignee: Sanyo Electric Co., Ltd., Daito-shi, Osaka (JP)

(21) Appl. No.: 15/550,409

(22) PCT Filed: Feb. 18, 2016
(86) PCT No.: PCT/JP2016/000866

§ 371 Date: Aug. 11, 2017

(30) Foreign Application Priority Data
Feb. 27, 2015 (JP) 2015-038301

(51) Int. Cl. H01M 10/44; H01M 10/052; H01M 4/62; H01M 2/16

(52) U.S. Cl. CPC H01M 10/445; H01M 2/1673; H01M 10/052; H01M 4/62; H01M 10/056

(57) ABSTRACT

The present invention aims to suppress gas generation during charge/discharge cycles, storage, and the like when a group IV to VI oxide, such as a lithium titanate, is used as a negative electrode active material. A non-aqueous electrolyte secondary battery includes a positive electrode having a positive electrode collector and a positive electrode mixture layer formed thereon, a negative electrode having a negative electrode collector and a negative electrode mixture layer formed thereon, and a fluorine-containing non-aqueous electrolyte. In the positive electrode mixture layer, a lithium transition metal oxide and a phosphoric acid compound are contained. In the negative electrode mixture layer, a group IV to VI oxide is contained which contains at least one type of element selected from a group IV element, a group V element, and a group VI element of the periodic table and which has a BET specific surface area of 2.0 m²/g or more.

### TECHNICAL FIELD

The present disclosure relates to a non-aqueous electrolyte secondary battery.

### BACKGROUND ART

Besides for consumer applications such as mobile information terminals including a mobile phone, a notebook personal computer, and a smart phone, non-aqueous electrolyte secondary batteries have also been used for power electric sources of an electric power tool, an electric vehicle (EV), a hybrid vehicle (a HEV or a PHEV), and the like and are expected to be further increasingly used in various new applications. In recent years, as a negative electrode active material having an excellent stability at a high potential, a lithium titanate has drawn attention. However, when a lithium titanate is used for a negative electrode active material, compared to the case in which a carbon-based negative electrode active material is used, for example, there has been a problem in that the amount of a gas generated during charge/discharge cycles and during storage is large.

In consideration of the situation described above, Patent Document 1 has proposed a non-aqueous electrolyte secondary battery in which a lithium titanate having a spinel structure, the surface of which is covered with a basic polymer, is used as a negative electrode active material. In addition, Patent Document 2 has proposed a non-aqueous electrolyte secondary battery using a lithium titanate as a negative electrode active material, the lithium titanate containing specific amounts of TiO₂, Li₂TiO₃, and Li₄Ti₅O₁₂ and having a crystalline strain of 0.0015 or less and a BET specific surface area in a range of 2 to 7 m²/g.

### CITATION LIST

### Patent Literature

Patent Document 1: International Publication No. 2012/111546

Patent Document 2: International Publication No. 2013/129423

### SUMMARY OF INVENTION

### Technical Problem

However, in a non-aqueous electrolyte secondary battery using a lithium titanate as a negative electrode active material, although the techniques disclosed in the above Patent Documents 1 and 2 are used, the gas generation during charge/discharge cycles, storage, and the like is difficult to suppress, and the above techniques are still desired to be improved from many aspects.

### Solution to Problem

A non-aqueous electrolyte secondary battery according to one aspect of the present disclosure is a non-aqueous electrolyte secondary battery which comprises a positive electrode including a positive electrode collector and a positive electrode mixture layer famed thereon, a negative electrode including a negative electrode collector and a negative electrode mixture layer famed thereon, and a fluorine-containing non-aqueous electrolyte. In the positive electrode mixture layer, a lithium transition metal oxide and a phosphoric acid compound are contained, and in the negative electrode mixture layer, a group IV to VI oxide is contained which contains at least one type of element selected from a group IV element, a group V element, and a group VI element of the periodic table and which has a BET specific surface area of 2.0 m²/g or more.

### Advantageous Effects of Invention

According to the non-aqueous electrolyte secondary battery of one aspect of the present disclosure, in the case in which the group IV to VI oxide, such as a lithium titanate, is used as the negative electrode active material, the gas generation during charge/discharge cycles, storage, and the like can be suppressed.

### BRIEF DESCRIPTION OF DRAWINGS

FIG. 1 is a cross-sectional view of a non-aqueous electrolyte secondary battery which is one example of an embodiment.

### DESCRIPTION OF EMBODIMENT

Although a group IV to VI oxide, such as a lithium titanate, has excellent characteristics as a negative electrode active material, the group IV to VI oxide contains many hydroxides on it surface, and in particular, when the BET specific surface area is 2.0 m²/g or more, the number of water molecules to be hydrogen-bonded to the hydroxides described above is increased, so that a large amount of moisture is adsorbed. Hence, when the group IV to VI oxide is used as the negative electrode active material, the amount of moisture to be carried into a battery is increased, and a gas generation amount during charge/discharge cycles and the like is increased. Since the moisture carried into by the group IV to VI oxide reacts with a fluorine-containing non-aqueous electrolyte to generate hydrogen fluoride (HF), a metal of a positive electrode active material is eluted by the HF thus generated, and corrosion of a positive electrode is advanced. Hence, it is believed that gases, such as H₂, CO, and CO₂, are generated.

Through intensive research carried out by the present inventors to solve the above problem, it was finally found that when a phosphoric acid compound is contained in a positive electrode mixture layer, in a non-aqueous electrolyte secondary battery using a group IV to VI oxide as a negative electrode active material, the gas generation can be specifically suppressed. It is believed that by the function of the phosphoric acid compound contained in the positive electrode mixture layer, a high-quality film is famed on the surface of the positive electrode active material from decomposed materials of the electrolyte, and metal elution from the positive electrode active material caused by HF is prevented. In addition, when a carbon-based negative electrode active material is used, even if a phosphoric acid compound is added to the positive electrode mixture layer, an effect of suppressing the gas generation is not observed (see Reference Examples described below).

Hereinafter, one example of an embodiment will be described in detail.

The drawing used for illustration of the embodiment is schematically drawn, and for example, a dimensional ratio of each constituent element shown in the drawing may be different from that of an actual element in some cases. A concrete dimensional ratio and the like are to be understood in consideration of the following description.

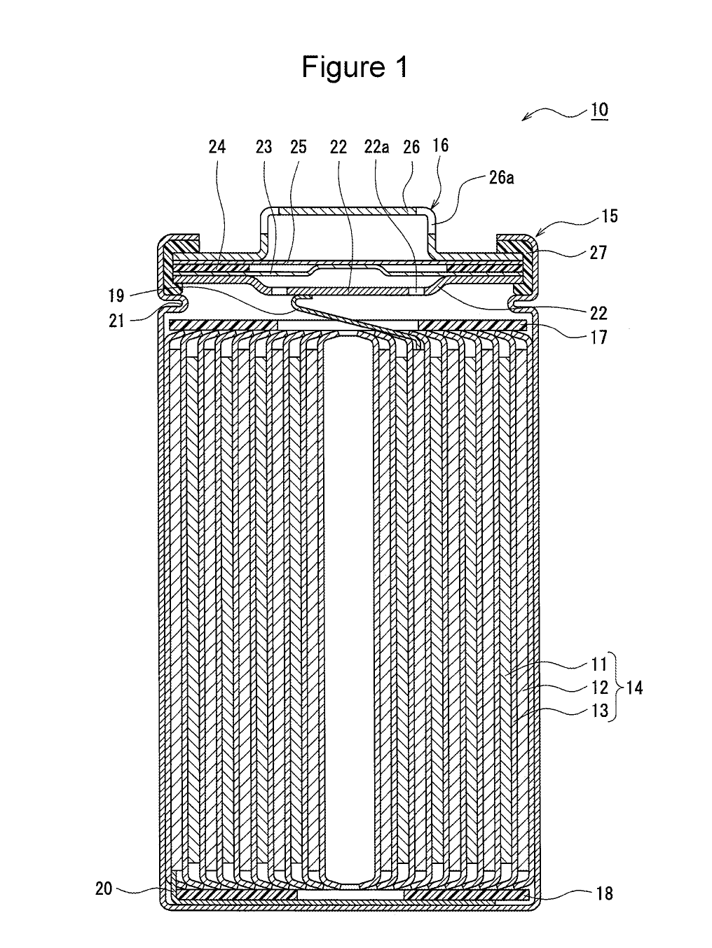

FIG. 1 is a cross-sectional view of a non-aqueous electrolyte secondary battery 10 which is one example of the embodiment.

The non-aqueous electrolyte secondary battery 10 comprises a positive electrode 11 including a positive electrode collector and a positive electrode mixture layer formed thereon, a negative electrode 12 including a negative electrode collector and a negative electrode mixture layer famed thereon, and a fluorine-containing non-aqueous electrolyte. Between the positive electrode 11 and the negative electrode 12, at least one separator 13 is preferably provided. The non-aqueous electrolyte secondary battery 10 has the structure in which a winding type electrode body 14 formed by winding the positive electrode 11 and the negative electrode 12 with the separator 13 interposed therebetween and the non-aqueous electrolyte are received in a battery case. Instead of the winding type electrode body 14, another electrode body, such as a lamination type electrode body famed by laminating positive electrodes and negative electrodes with separators interposed therebetween, may also be used. As the battery case receiving the electrode body 14 and the non-aqueous electrolyte, for example, there may be mentioned a metal-made case having a shape, such as a cylindrical, a square, a coin, or a button shape, or a resin-made case (laminate type battery) famed by laminating resin sheets. In the example shown in FIG. 1, the battery case is formed of a cylindrical case main body 15 having a bottom portion and a sealing body 16.

The non-aqueous electrolyte secondary battery 10 includes insulating plates 17 and 18 provided on a top and a bottom of the electrode body 14, respectively. In the example shown in FIG. 1, a positive electrode lead 19 fitted to the positive electrode 11 extends to a sealing body 16 side through a through-hole of the insulating plate 17, and a negative electrode lead 20 fitted to the negative electrode 12 extends to a bottom portion side of the case main body 15 along the outside of the insulating plate 18. For example, the positive electrode lead 19 is connected to a bottom surface of a filter 22, that is, to a bottom plate of the sealing body 16, by welding or the like, and a cap 26 which is a top plate of the sealing body 16 electrically connected to the filter 22 functions as a positive electrode terminal. The negative electrode lead 20 is connected to the inside of the bottom portion of the case main body 15 by welding or the like, and the case main body 15 functions as a negative electrode terminal. In this embodiment, for the sealing body 16, a current interruption device (CID) and a gas discharge mechanism (safety valve) are provided. In addition, a gas discharge valve is preferably provided for the bottom portion of the case main body 15.

The case main body 15 is, for example, a cylindrical metal-made container having a bottom portion. Between the case main body 15 and the sealing body 16, a gasket 27 is provided, so that the air tightness of the inside of the battery case can be secured. The case main body 15 preferably has a protrusion portion 21 famed, for example, by pressing a side surface portion from the outside so as to support the sealing body 16. The protrusion portion 21 is preferably formed to have a ring shape along the circumference direction of the case main body 15 and supports the sealing body 16 by the upper surface thereof.

The sealing body 16 includes the filter 22 in which a filter opening portion 22a is formed and a valve body disposed on the filter 22. The valve body blocks the filter opening portion 22a of the filter 22 and is fractured when the inside pressure of the battery is increased by heat generation caused by internal short circuit or the like. In this embodiment, as the valve body, a lower valve body 23 and an upper valve body 25 are provided, and an insulating member 24 disposed between the lower valve body 23 and the upper valve body 25 and the cap 26 having a cap opening portion 26a are further provided. The individual members foaming the sealing body 16 each have, for example, a circular shape or a ring shape and are electrically connected to each other except the insulating member 24. In particular, the filter 22 and the lower valve body 23 are bonded to each other along the circumference portions thereof, and the upper valve body 25 and the cap 26 are also bonded to each other along the circumference portions thereof. The lower valve body 23 and the upper valve body 25 are bonded to each other at the central portions thereof, and between the circumference portions thereof, the insulating member 24 is provided. When the inside pressure is increased by heat generation caused by internal short circuit or the like, for example, the lower valve body 23 is fractured at a thin wall portion thereof, and the upper valve body 25 is swelled toward a cap 26 side thereby and is separated from the lower valve body 23, so that the electrical connection therebetween is interrupted.

[Positive Electrode]

A positive electrode is formed of a positive electrode collector, such as metal foil, and a positive electrode mixture layer formed thereon. For the positive electrode collector, for example, there may be used foil made of a metal, such as aluminum, stable in a potential range of the positive electrode or a film in which the metal mentioned above is disposed as a surface layer. In the positive electrode mixture layer, a lithium transition metal oxide and a phosphoric acid compound are contained, and furthermore, an electrically conductive agent and a binding agent are preferably contained. It is believed that since the phosphoric acid compound is contained in the positive electrode mixture layer, a high-quality protective film is famed on the surface of the lithium transition metal oxide during charge, and the gas generation during charge/discharge cycles is suppressed. The positive electrode can be formed, for example, in such a way that after a positive electrode mixture slurry containing the lithium transition metal oxide, the phosphoric acid compound, the electrically conductive agent, the binding agent, and the like is applied onto the positive electrode collector, and coating films thus obtained are then dried, the positive electrode mixture layers are formed on two surfaces of the collector by rolling.

The lithium transition metal oxide functions as a positive electrode active material. As one example of a preferable lithium transition metal oxide, there may be mentioned an oxide containing as a transition metal, at least one selected from nickel (Ni), manganese (Mn), and cobalt (Co). In addition, the lithium transition metal oxide may contain a non-transition metal, such as aluminum (Al) or magnesium (Mg). As a metal element to be contained in the lithium transition metal oxide, besides Co, Ni, Mn, Al, and Mg, tungsten (W), boron (B), titanium (Ti), vanadium (V), iron (Fe), copper (Cu), zinc (Zn), niobium (Nb), zirconium (Zr), tin (Sn), tantalum (Ta), sodium (Na), potassium (K), barium (Ba), strontium (Sr), or calcium (Ca) may be mentioned by way of example.

As a particular example of the preferable lithium transition metal oxide, for example, lithium cobaltate or a composite oxide, such as a Ni—Co—Mn-based, a Ni—Co—Al-based, or a Ni—Mn—Al-based oxide, may be mentioned. The molar ratio of Ni, Co, and Mn of the Ni—Co—Mn-based lithium transition metal oxide is for example, 1:1:1, 5:2:3, 4:4:2, 5:3:2, 6:2:2, 55:25:20, 7:2:1, 7:1:2, or 8:1:1. In order to increase a positive electrode capacity, an oxide in which the rates of Ni and Co are each larger than that of Mn is preferably used, and in particular, an oxide in which the difference in molar rate between Ni and Mn to the total moles of Ni, Co, and Mn is 0.04% or more is preferable. The molar ratio of Ni, Co, and Al of the Ni—Co—Al-based lithium transition metal oxide is for example, 82:15:3, 82:12:6, 80:10:10, 80:15:5, 87:9:4, 90:5:5, or 95:3:2.

The lithium transition metal oxide preferably has a layered structure. However, the lithium transition metal oxide may also be an oxide, such as a lithium manganese oxide or a lithium nickel manganese oxide, having a spinel structure or an oxide having an olivine structure represented by LiMPO₄ (M: at least one selected from Fe, Mn, Co, and Ni). For the positive electrode active material, one type of lithium transition metal oxide may only be used, or at least two types thereof may be used by mixing.

The lithium transition metal oxide is for example, in the form of grains having an average grain diameter of 2 to 30 μm. The grains described above may be secondary grains famed by agglomerating primary grains having an average grain diameter of 100 nm to 10 μm. The average grain diameter of the lithium transition metal oxide is the median diameter (grain diameter obtained when the volume accumulation value of the grain distribution is 50%, hereinafter, referred to as “Dv50”) measured by a scattering grain size distribution measurement device (LA-750 manufactured by HORIBA, Ltd.).

In the lithium transition metal oxide, tungsten (W) is preferably solid-solved. Furthermore, to the surface of the lithium transition metal oxide, a tungsten oxide is preferably adhered. That is, W is preferably solid-solve in the lithium transition metal oxide, and in addition, to the surface of the metal oxide described above, a tungsten oxide is preferably adhered. Accordingly, for example, a more high-quality protective film is formed on the surface of the lithium transition metal oxide, and the gas generation during charge/discharge cycles can be further suppressed. When a tungsten oxide is contained in the positive electrode mixture layer, that is, when a tungsten oxide is present in the vicinity of the lithium transition metal oxide, although the advantage described above may be expected, a tungsten oxide is more preferably present so as to be adhered to the surface of the lithium transition metal oxide.

The content of W to be solid-solved in the lithium transition metal oxide is preferably 0.01 to 3.0 percent by mole with respect to the total moles of the metal elements other than Li, more preferably 0.03 to 2.0 percent by mole, and particularly preferably 0.05 to 1.0 percent by mole. When the content of the solid-solved W is in the range described above, without decreasing the positive electrode capacity, a high-quality film is likely to be formed on the surface of the lithium transition metal oxide. The state in which W is solid-solved in the lithium transition metal oxide indicates the state in which W partially replaces Ni, Co, and/or the like in the metal oxide and is present therein (state in which W is present in the crystal).

The solid solution of W in the lithium transition metal oxide and the solid solution amount thereof may be confirmed by an analysis performed in such a way that after the grain is cut, or the surface thereof is polished, the inside of the grain is observed using an Auger electron spectroscopy (AES), a Secondary Ion Mass Spectrometry (SIMS), and/or a Transmission Electron Microscope (TEM)-Energy dispersive X-ray spectrometry (EDX).

As a method in which W is solid-solved in the lithium transition metal oxide, for example, there may be mentioned a method in which a composite oxide containing Ni, Co, Mn, and the like, a lithium compound, such as lithium hydroxide or lithium carbonate, and a tungsten compound, such as a tungsten oxide, are mixed together and then fired. A firing temperature is preferably 650° C. to 1,000° C. and particularly preferably 700° C. to 950° C. When the firing temperature is less than 650° C., for example, a decomposition reaction of lithium hydroxide is not sufficient, and the reaction may not be likely to proceed in some cases. When the firing temperature is more than 1,000° C., for example, cation mixing is activated, and for example, a decrease in specific capacity and a degradation in load characteristics may occur in some cases.

The content of the tungsten oxide contained in the positive electrode mixture layer on the W element basis is with respect to the total moles of the metal elements other than Li of the lithium transition metal oxide, preferably 0.01 to 3.0 percent by mole, more preferably 0.03 to 2.0 percent by mole, and particularly preferably 0.05 to 1.0 percent by mole. Most of the tungsten oxide is preferably adhered to the surface of the lithium transition metal oxide. That is, the content of the tungsten oxide adhered to the surface of the lithium transition metal oxide on the W element basis is preferably 0.01 to 3.0 percent by mole with respect to the total moles of the metal elements other than Li of the metal oxide described above. When the content of the tungsten oxide is within the range described above, without decreasing the positive electrode capacity, a high-quality film is likely to be formed on the surface of the lithium transition metal oxide.

The tungsten oxide is preferably dispersedly adhered to the surface of the lithium transition metal oxide. The tungsten oxide is not locally present by agglomeration on parts of the surface of the lithium transition metal oxide and is uniformly adhered to the entire surface thereof. As the tungsten oxide, for example, WO₃, WO₂, and W₂O₃ may be mentioned. Among those compounds mentioned above, WO₃ is preferable since having a most stable hexavalent value as the oxidation number of W.

The average grain diameter of the tungsten oxide is preferably smaller than that of the lithium transition metal oxide and in particular, is preferably smaller than one fourth thereof. When the average grain diameter of the tungsten oxide is larger than that of the lithium transition metal oxide, the contact area to the lithium transition metal oxide is decreased, and as a result, the above advantage may not be sufficiently obtained in some cases. The average grain diameter of the tungsten oxide adhered to the surface of the lithium transition metal oxide may be measured using a scanning electron microscope (SEM). In particular, from a SEM image of positive electrode active material grains (lithium transition metal oxide having a surface to which the tungsten oxide is adhered), after 100 grains of the tungsten oxide are randomly selected, and the maximum major axes of the grains are measured, the average of the measured data is regarded as the average grain diameter. The average grain diameter of the tungsten oxide measured by the method described above is for example, 100 nm to 5 μm and preferably 100 nm to 1 μm.

As a method to adhere the tungsten oxide to the surface of the lithium transition metal oxide, for example, there may be mentioned a method in which the lithium transition metal oxide and the tungsten oxide are mechanically mixed with each other. Alternatively, in a step of forming a positive electrode mixture slurry, the tungsten oxide is added to a slurry raw material, such as the positive electrode active material, so that the tungsten oxide is adhered to the surface of the lithium transition metal oxide. In order to increase the amount of the tungsten oxide adhered to the surface of the lithium transition metal oxide, the former method is preferably used.

In the positive electrode mixture layer, the phosphoric acid compound is contained as described above. The phosphoric acid compound forms a high-quality protective film on the surface of the lithium transition metal oxide. Although the phosphoric acid compound is not particularly limited, for example, there may be used lithium phosphate, lithium dihydrogen phosphate, cobalt phosphate, nickel phosphate, manganese phosphate, potassium phosphate, calcium phosphate, sodium phosphate, magnesium phosphate, ammonium phosphate, or ammonium dihydrogen phosphate, and in addition, a mixture containing at least two types of those mentioned above may also be used. In view of the stabilization of the phosphoric acid compound in an overcharge state, among the compounds mentioned above, a lithium phosphate is preferable. As the lithium phosphate, for example, although lithium dihydrogen phosphate, lithium hydrogen phosphite, lithium monofluorophosphate, or lithium difluorophosphate may be used, Li₃PO₄ is preferable. The lithium phosphate is for example, in the form of grains having a Dv50 of 50 nm to 10 μm and is preferably in the form of grains having a Dv50 of 100 nm to 1 μm.

The content of the phosphoric acid compound contained in the positive electrode mixture layer is preferably 0.1 to 5.0 percent by mass with respect to the mass of the positive electrode active material, more preferably 0.5 to 4.0 percent by mass, and particularly preferably 1.0 to 3.0 percent by mass. When the content of the phosphoric acid compound is in the range described above, without decreasing the positive electrode capacity, a high-quality film is likely to be formed on the surface of the lithium transition metal oxide, and during charge/discharge cycles, the gas generation can be efficiently suppressed.

As a method in which the phosphoric acid compound is contained in the positive electrode mixture layer, for example, a method for adding the phosphoric acid compound to the positive electrode mixture layer may be performed by mechanically mixing in advance, the phosphoric acid compound and the lithium transition metal oxide having a surface to which the tungsten oxide is adhered. Alternatively, in a step of foaming the positive electrode mixture slurry, a lithium phosphate may be added to a slurry raw material, such as the positive electrode active material.

As the electrically conductive agent contained in the positive electrode mixture layer, carbon materials, such as carbon black, acetylene black, ketjen black, graphite, vapor grown carbon (VGCF), carbon nanotubes, and carbon nanofibers, may be mentioned. Those materials may be used alone, or at least two types thereof may be used in combination.

As the binding agent contained in the positive electrode mixture layer, for example, there may be mentioned a fluorine resin, such as a polytetrafluoroethylene (PTFE) or a poly(vinylidene fluoride) (PVdF), a polyolefin resin, such as an ethylene-propylene-isoprene copolymer or an ethylene-propylene-butadiene copolymer, a polyacrylonitrile (PAN), a polyimide resin, or an acrylic resin. In addition, together with at least one of the resins mentioned above, for example, a carboxymethyl cellulose (CMC) or its salt (such as CMC-Na, CMC-K, CMC-NH₄, or its partially neutralized salt), or a poly(ethylene oxide) (PEO) may also be used. Those compounds may be used alone, or at least two types thereof may be used in combination.

[Negative Electrode]

A negative electrode is formed of a negative electrode collector, such as metal foil, and a negative electrode mixture layer formed thereon. For the negative electrode collector, for example, there may be used foil made of a metal, such as copper, stable in a potential range of the negative electrode or a film in which the metal mentioned above is disposed as a surface layer. When a lithium titanate is used as the negative electrode active material, as the negative electrode collector, for example, although aluminum foil is preferable, copper foil may also be used, and in addition, nickel foil, stainless steel foil, or the like may also be used. In the negative electrode mixture layer, a group IV to VI oxide is contained which contains at least one element selected from a group IV element, a group V element, and a group VI element of the periodic table and which has a BET specific surface area of 2.0 m²/g or more. In the negative electrode mixture layer, an electrically conductive agent and a binding agent are preferably further contained. The negative electrode may be formed, for example, in such a way that after a negative electrode mixture slurry containing the group IV to VI oxide, the binding agent, and the like is applied onto the negative electrode collector, and coating films thus obtained are then dried, the negative electrode mixture layers are formed on two surfaces of the collector by rolling.

The group IV to VI oxide functions as a negative electrode active material. As the group IV element, the group V element, and the group VI element of the element periodic table, for example, titanium (Ti), zirconium (Zr), hafnium (Hf), vanadium (V), niobium (Nb), tantalum (Ta), chromium (Cr), molybdenum (Mo), or tungsten (W) may be mentioned. For the group IV to VI oxide, at least one type oxide selected from a titanium oxide containing Ti, a niobium oxide containing Nb, and a tungsten oxide containing W is preferably used, and among those oxides mentioned above, the titanium oxide is particularly preferable.

As the titanium oxide described above, for example, there may be mentioned titanium dioxide (TiO₂) or a lithium-containing titanium oxide. In view of output characteristics, the stability during charge/discharge, and the like, a lithium-containing titanium oxide is preferably used, and in particular, a lithium titanate is more preferable, and a lithium titanate having a spinel crystal structure is particularly preferable. The lithium titanate having a spinel crystal structure is for example, represented by Li₄₊ₓTi₅O₁₂ (0≦X≦3). In addition, Ti of a lithium titanate may be partially replaced by at least one another element. The lithium titanate having a spinel crystal structure has a small expansion/contraction in association with insertion and release of lithium ions and is not likely to be degraded. Hence, when the oxide described above is used for the negative electrode active material, a battery having an excellent durability can be obtained. The spinel structure of a lithium titanate may be confirmed, for example, by an X-ray diffraction measurement.

The group IV to VI oxide (lithium titanate) is, for example, in the form of grains having a Dv50 of 0.1 to 10 μm. Although the BET specific surface area of the group IV to VI oxide is 2 m²/g or more, the BET specific surface area thereof is more preferably 3 m²/g or more and particularly preferably 4 m²/g or more. The BET specific surface area may be measured by a BET method using a specific surface area measurement device (Tristar II 3020 manufactured by Shimadzu Corporation). When the specific surface area of the group IV to VI oxide is less than 2 m²/g, the amount of moisture carried into the battery is decreased, input/output characteristics tends to be insufficient, and in addition, the effect of suppressing the gas generation is decreased. On the other hand, when the specific surface area of the group IV to VI oxide is excessively increased, the crystallinity thereof is degraded, and the durability is liable to be degraded; hence, the specific surface area is preferably 8 m²/g or less.

As the negative electrode active material, the group IV to VI oxide, in particular, a lithium titanate, is preferably used alone. However, the group IV to VI oxide may also be used by mixing with another negative electrode active material. As the negative electrode active material, any material may be used without any particular restriction as long as being capable of reversibly inserting and releasing lithium ions, and for example, there may be used a carbon material, such as natural graphite or artificial graphite; a metal, such as silicon (Si) or tin (Sn), foaming an alloy with lithium; or an alloy or a composite oxide, each of which contains a metal element, such as Si or Sn. When the group IV to VI oxide is used by mixing with another negative electrode active material, the content of the group IV to VI oxide is preferably 80 percent by mass or more with respect to the total mass of the negative electrode active material.

As the electrically conductive agent contained in the negative electrode mixture layer, for example, a carbon material similar to that of the positive electrode may be used. As the binding agent contained in the negative electrode mixture layer, as is the case of the positive electrode, for example, a fluorinated resin, a PAN, a polyimide resin, an acrylic resin, or a polyolefin resin may be used. When a mixture slurry is prepared using an aqueous solvent, for example, there may be preferably used a CMC or its salt (such as CMC-Na, CMC-K, CMC-NH₄, or a partially neutralized salt thereof), a styrene-butadiene rubber (SBR), a polyacrylic acid (PAA) or its salt (such as PAA-Na, PAA-K, or a partially neutralized salt thereof), or a poly(vinyl alcohol) (PVA).

[Separator]

For the separator, a porous sheet having an ion permeability and an insulating property is used. As a particular example of the porous sheet, for example, a fine porous thin film, a woven cloth, or a non-woven cloth may be mentioned. Although the type of separator is not particularly limited, in view of heat resistance, durability, and the like, a polypropylene layer is preferably contained. The polypropylene layer is a porous layer formed from a polypropylene (PP) as a primary component and may have a single layer structure formed only from a polypropylene layer. Alternately, the separator may have a multilayer structure including a polyethylene layer (porous layer famed from a polyethylene (PE) as a primary component) and the above polypropylene layer, such as a three-layered structure (PP/PE/PP) formed of a polyethylene layer as a central layer and two polypropylene layers provided at the two sides thereof as surface layers. Although excellent in mechanical strength, the separator including a polypropylene layer has a low flexibility, and when the mesh size thereof is fine, decomposed material of the electrolyte are liable to clog the mesh; however, in the battery of this embodiment, since the decomposition of the electrolyte is suppressed by the function of a lithium phosphate contained in the positive electrode mixture layer, the clogging as described above is not likely to generate. The average pore diameter of the separator is preferably 0.01 to 1 μm, and an average pore diameter of 0.01 to 0.1 μm is particularly preferable since the above clogging suppression effect is significant.

The separator may be formed by applying an aramid resin or the like onto a surface of the porous sheet. In addition, on the interface between the separator and at least one of the positive electrode and the negative electrode, a filler layer containing an inorganic filler may also be famed. As the inorganic filler, for example, an oxide containing at least one of titanium (Ti), aluminum (Al), silicon (Si), and magnesium (Mg) may be mentioned. The filler layer may be famed, for example, by applying a slurry containing the filler mentioned above onto the surface of the positive electrode, the negative electrode, or the separator.

[Non-Aqueous Electrolyte]

As the non-aqueous electrolyte, a fluorine-containing non-aqueous electrolyte containing fluorine (F) is used. The fluorine-containing non-aqueous electrolyte contains for example, a non-aqueous solvent and a fluorine-containing electrolyte salt (solute) dissolved therein. The non-aqueous electrolyte is not limited to a liquid electrolyte (non-aqueous electrolyte liquid) and may be a solid electrolyte using a gel polymer or the like. The non-aqueous solvent may be a halogen substitute in which at least one hydrogen atom of a solvent molecule is replaced by a halogen atom, such as a fluorine atom.

As the non-aqueous solvent, for example, there may be used a cyclic carbonate, such as ethylene carbonate, propylene carbonate, butylene carbonate, or vinylene carbonate; or a chain carbonate, such as dimethyl carbonate, ethyl methyl carbonate, or diethyl carbonate. In particular, in order to suppress the gas generation, a cyclic carbonate is preferably contained. By the use of a cyclic carbonate, since a high-quality film is formed on the surface of the lithium transition metal oxide, corrosion of the positive electrode active material and metal elution, each of which is caused by HF, are suppressed, so that the gas generation during charge/discharge cycles can be further suppressed.

As the cyclic carbonate, propylene carbonate is preferably used. Since propylene carbonate is not likely to be decomposed, the gas generation amount can be reduced. In addition, by the use of propylene carbonate, excellent low-temperature input/output characteristics can be obtained. When a carbon material is used as the negative electrode active material, if polypropylene carbonate is contained, since an irreversible charge reaction may occur in some case, together with propylene carbonate, for example, ethylene carbonate and/or fluoroethylene carbonate is preferably used. On the other hand, when a lithium titanate is used as the negative electrode active material, since an irreversible charge reaction is not likely to occur, the rate of propylene carbonate occupied in the cyclic carbonate is preferably large. For example, the rate of polypropylene carbonate occupied in the cyclic carbonate is 80 percent by volume or more or is more preferably 90 percent by volume or more, and may also be 100 percent by volume.

In order to decrease the viscosity, decrease the melting point, improve the lithium ion conductivity, and the like, as the non-aqueous solvent, a mixed solvent of the cyclic carbonate and the chain carbonate is preferably used. The volume ratio of the cyclic carbonate to the chain carbonate in this mixed solvent is preferably in a range of 2:8 to 5:5.

Together with the solvent described above, a compound containing an ester, such as methyl acetate, ethyl acetate, propyl acetate, methyl propionate, ethyl propionate, or γ-butyrolactone may be used. In addition, for example, a compound containing a sulfone group, such as propane sultone, a compound containing an ether, such as 1,2-dimethoxyethane, 1,2-diethoxyethane, tetrahydrofuran, 1,3-dioxane, 1,4-dioxane, or 2-methyltetrahydrofuran, a compound containing a nitrile, such as butyronitrile, valeronitrile, n-heptane nitrile, succinonitrile, glutaronitrile, adiponitrile, pimelonitrile, 1,2,3-propane tricarbonitrile, or 1,3,5-pentane tricarbonitrile, or a compound containing an amide, such as dimethylformamide, may also be used together with the solvent mentioned above.

As the electrolyte salt, a fluorine-containing lithium salt is preferably used. As the fluorine-containing lithium salt, for example, there may be mentioned LiPF₆, LiBF₄, LiCF₃SO₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃, or LiAsF₆. Besides the fluorine-containing lithium salt, a lithium salt [lithium salt (such as LiClO₄ or LiPO₂F₂) containing at least one type of element selected from P, B, O, S, N, and Cl] other than the fluorine-containing lithium salt may also be added. The concentration of the electrolyte salt is preferably set to 0.8 to 1.8 moles per one liter of the non-aqueous solvent.

### EXPERIMENTAL EXAMPLES

Hereinafter, although the present disclosure will be further described with reference to Experimental Examples, the present disclosure is not limited to the following Experimental Examples.

### Experimental Example 1

[Formation of Positive Electrode Active Material]

A hydroxide represented by [Ni_{0.50}Co_{0.20}Mn_{0.30}](OH)₂ obtained by co-precipitation was fired at 500° C., so that a nickel cobalt manganese composite oxide was obtained. Next, lithium carbonate, the nickel cobalt manganese composite oxide described above, and a tungsten oxide (WO₃) were mixed together using an Ishikawa type grinding mortar so that the molar ratio of Li, the total of Ni, Co, and Mn, and W in WO₃ was 1.2:1:0.005. This mixture was heat-treated at 900° C. for 20 hours in an air atmosphere and then pulverized, so that a lithium transition metal oxide represented by Li_{1.07}[Ni_{0.465}CO_{0.186}Mn_{0.279}W_{0.005}]O₂ in which tungsten was solid-solved was obtained. By observation of a powder of the composite oxide thus obtained using a scanning electron microscope (SEM), it was confirmed that no un-reacted product of the tungsten oxide remained.

The above lithium transition metal oxide and a tungsten oxide (WO₃) were mixed with each other using a Hivis Disper Mix (manufactured by Primix Corporation), so that a positive electrode active material in which WO₃ was adhered to the surface of the lithium transition metal oxide was formed. In this case, mixing was performed so that the molar ratio of the metal elements (Ni, Co, Mn, and W) other than Li in the lithium transition metal oxide to W in WO₃ was 1:0.005.

[Formation of Positive Electrode]

The above positive electrode active material and a lithium phosphate (Li₃PO₄) in an amount of 2 percent by mass with respect to that of the active material were mixed together. The mixture thus obtained, acetylene black, and a poly(vinylidene fluoride) were mixed together at a mass ratio of 93.5:5:1.5, and after an appropriate amount of N-methyl-2-pyrrolidone was added thereto, kneading was performed, so that a positive electrode mixture slurry was prepared. After the positive electrode mixture slurry thus prepared was applied onto two surfaces of a positive electrode collector famed of aluminum foil, and coating films thus formed were then dried, rolling was performed using a rolling roller machine, and an aluminum-made collector tab was further fitted, so that a positive electrode in which positive electrode mixture layers were famed on the two surfaces of the positive electrode collector was formed. By observation of the positive electrode thus obtained using a SEM, it was confirmed that tungsten oxide grains having an average grain diameter of 150 nm were adhered to grain surfaces of the lithium transition metal oxide.

[Formation of Negative Electrode Active Material]

Raw material powders, LiOH.H₂O which was a commercially available reagent and TiO₂, were weighed so that the molar ratio of Li to Ti was set slightly larger than the stoichiometric ratio, that is, so as to be slightly Li-rich, and were then mixed together using a mortar. For the TiO₂ used as a raw material, a TiO₂ having an anatase crystal structure was used. After the raw material powders thus mixed together were placed in an Al₂O₃-made crucible and then heat-treated at 850° C. for 12 hours in an air atmosphere, a material thus heat-treated was pulverized using a mortar, so that a crude powder of a lithium titanate (Li₄Ti₅O₁₂) was obtained. By powder X-ray diffraction measurement of the crude powder of Li₄Ti₅O₁₂ thus obtained, a single phase diffraction pattern of a spinel structure which belonged to an Fd3m space group was obtained. The crude powder of Li₄Ti₅O₁₂ was processed by jet-mill pulverization and classification, so that a Li₄Ti₅O₁₂ powder having a Dv50 of 0.7 μm was obtained. This Li₄Ti₅O₁₂ powder was used as a negative electrode active material. The BET specific surface area of the Li₄Ti₅O₁₂ powder measured by a specific surface area measurement device (Tristar II 3020 manufactured by Shimadzu Corporation) was 6.8 m²/g.

[Formation of Negative Electrode]

After the above negative electrode active material, carbon black, and a poly(vinylidene fluoride) were mixed together at a mass ratio of 100:7:3, and an appropriate amount of N-methyl-2-pyrrolidone was added thereto, kneading was performed, so that a negative electrode mixture slurry was prepared. After the negative electrode mixture slurry described above was applied onto two surfaces of a negative electrode collector famed of aluminum foil, and coating films thus famed were dried, rolling was performed using a rolling roller machine, and a nickel-made collector tab was further fitted, so that a negative electrode in which negative electrode mixture layers were famed on the two surfaces of the negative electrode collector was formed.

[Preparation of Non-Aqueous Electrolyte]

In a mixed solvent obtained by mixing propylene carbonate (PC), ethyl methyl carbonate (EMC), and dimethyl carbonate (DMC) at a volume ratio of 25:35:40, LiPF₆ was dissolved at a rate of 1.2 moles/liter, so that a fluorine-containing non-aqueous electrolyte was prepared.

[Formation of Battery]

The positive electrode and the negative electrode were wound with at least one separator having a three-layered structure formed from a polypropylene (PP), a polyethylene (PE), and a polypropylene (PP) interposed therebetween and were then vacuum-dried at 105° C. for 150 minutes, so that a winding type electrode body was formed. In a glove box in an argon atmosphere, the electrode body and the non-aqueous electrolyte were sealed in an outer package formed of an aluminum laminate sheet, so that a battery A1 was formed. A design capacity of the battery A1 was 15.6 mAh.

### Experimental Example 2

In the formation of the positive electrode, except that Li₃PO₄ was not mixed, a battery A2 was famed in a manner similar to that of the above Experimental Example 1.

[Evaluation of Gas Generation Amount]

After Charge/discharge was performed 5 cycles on the batteries A1 and A2 under the following conditions, the batteries were stored for 3 days, and the gas generation amounts thereof were then obtained.

(Charge/Discharge Conditions)

Charge/discharge conditions for the first cycle: In a temperature environment of 25° C., constant current charge was performed at a charge current of 0.22 It (3.5 mA) to a battery voltage of 2.65 V, and next, constant current discharge was performed at a discharge current of 0.22 It (3.5 mA) to 1.5 V.

Charge/discharge conditions for the second to 5th cycle: In a temperature environment of 25° C., constant current charge was performed at a charge current of 2.3 It (36 mA) to a battery voltage of 2.65 V, and furthermore, constant voltage charge was performed at a constant battery voltage of 2.65 V to a current of 0.03 It (0.5 mA). Next, constant current discharge was performed at a discharge current of 2.3 It (36 mA) to 1.5 V.

In addition, a rest interval between the charge and the discharge was set to 10 minutes.

(Storage Conditions)

After the above charge/discharge were performed 5 cycles, in a temperature environment of 25° C., constant current charge was performed to 2.65 V. Subsequently, the battery was statically left in a temperature environment of 60° C. for 3 days and was then further discharged in a temperature environment of 25° C.

(Calculation of Gas Generation Amount)

By using the Archimedes method, before the charge/discharge and after the storage test, the difference between the battery mass in the air and that in water was measured for each battery, and the buoyancy (volume) of the battery was calculated. The difference in buoyancy before the charge/discharge test and after the storage test was regarded as the gas generation amount.

TABLE 1

| | Positive electrode | | | | Gas Generation |
|---|---|---|---|---|---|
| Bat- | Solid- | | | Negative electrode | Amount |
| tery | solved W | WO₃ | Li₃PO₄ | active material | (cm³) |
| A1 | Yes | Yes | Yes | Li₄Ti₅O₁₂ | 0.55 |
| A2 | Yes | Yes | No | Li₄Ti₅O₁₂ | 0.60 |

In the battery A1 in which a lithium phosphate was mixed in the positive electrode, compared to the battery A2 in which no lithium phosphate was mixed, the gas generation amount was small.

In the battery A1, it is believed that since a lithium phosphate is present in the positive electrode mixture layer, oxidation decomposition of the electrolyte liquid at the surface of the positive electrode active material is promoted, and a high-quality film having an excellent function to protect the positive electrode active material from HF is famed from decomposed materials, so that the gas generation amount is decreased. On the other hand, in the battery A2, it is believed that since a high-quality film is not formed on the surface of the positive electrode active material, the positive electrode active material is corroded by HF, and as a result, the gas generation amount is increased.

In the batteries A1 and A2, although the separator having a three-layered structure famed from PP/PE/PP was used as the separator, for example, even when a separator having a single layer structure formed only from a PE layer or a PP layer is used, it is expected to obtain a result similar to that described above.

### Reference Example 1

Except for the following changes, a battery B1 was formed in a manner similar to that of Experimental Example 1 (the positive electrode was the same as that of Experimental Example 1).

In the formation of the negative electrode, after a clumped graphite powder, a carboxymethyl cellulose (CMC), and a styrene-butadiene rubber (SBR) were mixed together at a mass ratio of 100:1:1.5, and an appropriate amount of water was added thereto, kneading was performed, so that a negative electrode mixture slurry was prepared. The above negative electrode mixture slurry was applied onto two surfaces of a negative electrode collector formed from copper foil, so that a negative electrode was formed. The BET specific surface area of the graphite powder was 6.6 m²/g.

In the preparation of the non-aqueous electrolyte, in a mixed solvent in which ethylene carbonate (EC), EMC, and DMC were mixed together at a volume ratio of 3:3:4, LiPF₆ was dissolved at a rate of 1.0 mole per liter.

### Reference Example 2

In the formation of the positive electrode, except that Li₃PO₄ was not mixed, a battery B2 was formed in a manner similar to that of the above Reference Example 1.

In addition, in the batteries A1 and A2 using a lithium titanate as the negative electrode active material, although the electrolyte liquid containing PC as the solvent was used, in the batteries B1 and B2 using graphite as the negative electrode active material, the electrolyte liquid containing EC as the solvent was used. The reason for this is that in the case in which a carbon material is used as the negative electrode active material, when PC is contained, an irreversible charge reaction may occur in some cases.

[Evaluation of Gas Generation Amount]

The gas generation amount of each of the batteries B1 and B2 was obtained after the above storage test was performed. However, as for the voltage range, charge and discharge were set to up to 4.2 V and up to 2.5 V, respectively.

TABLE 2

| | Positive electrode | | | | Gas Generation |
|---|---|---|---|---|---|
| Bat- | Solid- | | | Negative electrode | Amount |
| tery | solved W | WO₃ | Li₃PO₄ | active material | (cm³) |
| B1 | Yes | Yes | Yes | Graphite | 0.48 |
| B2 | Yes | Yes | No | Graphite | 0.42 |

When a lithium titanate was used as the negative electrode active material, the gas generation amount of the battery A1 which contained a lithium phosphate was smaller than that of the battery A2 which contained no lithium phosphate, and on the other hand, when graphite was used as the negative electrode active material, the gas generation amount of the battery B2 which contained no lithium phosphate was larger than that of the battery B1 which contained a lithium phosphate.

In the battery B1, as is the case of the battery A1, it is believed that since a lithium phosphate is present in the positive electrode mixture layer, oxidation decomposition of the electrolyte liquid at the surface of the positive electrode active material is promoted, and a film which protects the positive electrode active material from HF is famed. In this case, it is believed that compared to the film formed in the battery B2 from decomposed materials, the film formed in the battery B1 is likely to protect the positive electrode active material from HF; however, in the batteries B1 and B2, since graphite is used as the negative electrode active material, the amount of moisture to be mixed into the battery is small, and hence the generation of HF is also suppressed. Accordingly, it is believed that the effect obtained by addition of a lithium phosphate is hardly observed (in the battery B1, the gas generation amount is further increased as compared to that of the battery B2). In addition, since the number of hydroxides present on the surface of graphite is smaller than that of a lithium titanate, it is believed that the amount of moisture to be carried into the battery when graphite is used is decreased. However, when graphite is used, the input/output characteristics are degraded as compared to the case in which a lithium titanate is used.

That is, only when a lithium titanate is used as the negative electrode active material, and a lithium phosphate is mixed in the positive electrode, the gas generation can be specifically suppressed.

### REFERENCE SIGNS LIST

10 non-aqueous electrolyte secondary battery, 11 positive electrode, 12 negative electrode, 13 separator, 14 electrode body, 15 case main body, 16 sealing body, 17, 18 insulating plate, 19 positive electrode lead, 20 negative electrode lead, 22 filter, 22a filter opening portion, 23 lower valve body, 24 insulating member, 25 upper valve body, cap, 26a cap opening portion, 27 gasket

1. A non-aqueous electrolyte secondary battery comprising: a positive electrode including a positive electrode collector and a positive electrode mixture layer formed thereon; a negative electrode including a negative electrode collector and a negative electrode mixture layer formed thereon; and a fluorine-containing non-aqueous electrolyte,
wherein in the positive electrode mixture layer, a lithium transition metal oxide and a phosphoric acid compound are contained, and
in the negative electrode mixture layer, a group IV to VI oxide is contained which contains at least one type of element selected from a group IV element, a group V element, and a group VI element of the periodic table and which has a BET specific surface area of 2.0 m²/g or more.

2. The non-aqueous electrolyte secondary battery according to claim 1, wherein the group IV to VI oxide is a lithium titanate.

3. The non-aqueous electrolyte secondary battery according to claim 1, wherein the phosphoric acid compound is a lithium phosphate.

4. The non-aqueous electrolyte secondary battery according to claim 1, wherein in the lithium transition metal oxide, tungsten is solid-solved, and to the surface of the metal oxide, a tungsten oxide is adhered.

5. The non-aqueous electrolyte secondary battery according to claim 4, wherein the tungsten oxide is WO₃.

6. The non-aqueous electrolyte secondary battery according to claim 1, further comprising a separator interposed between the positive electrode and the negative electrode,
wherein the separator includes a polypropylene layer.
